(19) United States
(12) Patent Application Publication
(10) Pub. No.: US 2015/0035799 A1
(43) Pub. Date: Feb. 5, 2015

(54) OPTICAL TOUCHSCREEN

(71) Applicant: Quanta Computer Inc., Taoyuan Shien (TW)

(72) Inventors: Chien-Hung LIN, Guishan Township (TW); Yun-Cheng LIU, New Taipei City (TW)

(73) Assignee: Quanta Computer Inc., Taoyuan Shien (TW)

(21) Appl. No.: 14/139,417

(22) Filed: Dec. 23, 2013

(30) Foreign Application Priority Data
Jul. 31, 2013 (TW) 102127450

(51) Int. Cl. G06F 3/042

(52) U.S. Cl. CPC G06F 3/0421
USPC 345/175

(57) ABSTRACT

An optical touchscreen includes a transparent panel, a plurality of optical modules, and at least one retro-reflector. The transparent panel includes a first surface and a second surface opposite to each other, a plurality of corners, and a plurality of edges. The optical modules are respectively disposed on the corners, and each optical module includes an incident-light unit and a sensor. The incident-light unit is used for emitting an incident light, so that the incident light enters and passes through the transparent panel via total reflection between the first surface and the second surface. The sensor is disposed on one side of the incident-light unit. The retro-reflector is disposed on the edges, and the retro-reflector is used to reflect the incident light, so that the incident light is reflected by the retro-reflector, and the reflected incident light goes in a reversed path within the transparent panel and is captured by the sensor.

### CROSS-REFERENCE TO RELATED APPLICATIONS

This application claims priority to Taiwan Application Serial Number 102127450, filed Jul. 31, 2013, which are herein incorporated by reference.

### FIELD OF THE INVENTION

The present invention relates to a touchscreen. More particularly, the present invention relates to an optical touchscreen.

### BACKGROUND

Touch technology refers to a combination of a display and input module of an electronic device. A user can control the electronic device simply by pressing or touching the display. The touchscreen is normally categorized into types of resistive, capacitive, and optical. For the optical touchscreen, because traces used for sensing need not to be disposed under the whole panel, this type of the touchscreen may have the cost advantage in large-size touchscreen.

The light sources and the receivers of the optical touchscreen are disposed on the edges or the corners of the screen. The light sources emit light, which is invisible such as infrared ray, above the screen. When a user touches the screen by his finger, an infrared ray with a specified direction is blocked by the finger, such that the receiver would not receive the infrared ray with the specified direction. Therefore, the position where the finger touches the screen can be located after calculation.

In order to emit the infrared ray above the screen, the light sources and the receivers must be disposed above the screen. Accordingly, the thickness of the optical touchscreen increases.

### SUMMARY

This disclosure provides an optical touchscreen to reduce a thickness of the touchscreen.

In one embodiment, an optical touchscreen is provided. An optical touchscreen includes a transparent panel, a plurality of optical modules, and at least one retro-reflector. The transparent panel includes a first surface and a second surface opposite to each other, a plurality of corners, and a plurality of edges. The optical modules are respectively disposed on the corners, and each optical module includes an incident-light unit and a sensor. The incident-light unit is used for emitting an incident light, so that the incident light enters and passes through the transparent panel via total reflection between the first surface and the second surface. The sensor is disposed on one side of the incident-light unit. The retro-reflector is disposed on the edges, and the retro-reflector is used to reflect the incident light, so that the incident light is reflected by the retro-reflector and that the reflected incident light goes in a reversed path within the transparent panel and is captured by the sensor.

By the well-designed optical module, when a user touches the transparent panel by his finger, the total reflection may be destroyed, and the intensity of the incident light may decrease. Therefore, a light signal from a specific direction received by the sensor may be weaken, so the position where the finger touches the panel can be known. As a result, the optical module can be disposed on the side surface of the transparent panel without being disposed above the transparent panel, so as to planarize the optical touchscreen.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of an optical touchscreen according to one embodiment of this invention;

FIG. 2A is a cross-sectional view taken along line A-A of FIG. 1;

FIG. 2B is a cross-sectional view of the optical touchscreen of FIG. 2A when the optical touchscreen is touched by a finger;

FIG. 3 is a schematic cross-sectional view of the optical touchscreen according to one embodiment of this invention;

FIG. 4 is a schematic top view of the optical touchscreen according to one embodiment of this invention;

FIG. 5A is an image formed by the sensor when there is no object on the transparent panel according to one embodiment of this invention;

FIG. 5B is an image formed by the sensor when there is an object on the transparent panel according to one embodiment of this invention;

FIG. 6 is a schematic top view of the optical touchscreen when there is an object on the transparent panel according to one embodiment of this invention;

FIG. 7 is a cross-sectional view of the optical touchscreen according to another embodiment of this invention;

FIG. 8 is a cross-sectional view of the optical touchscreen according to another embodiment of this invention; and

FIG. 9 is a cross-sectional view of the optical touchscreen according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

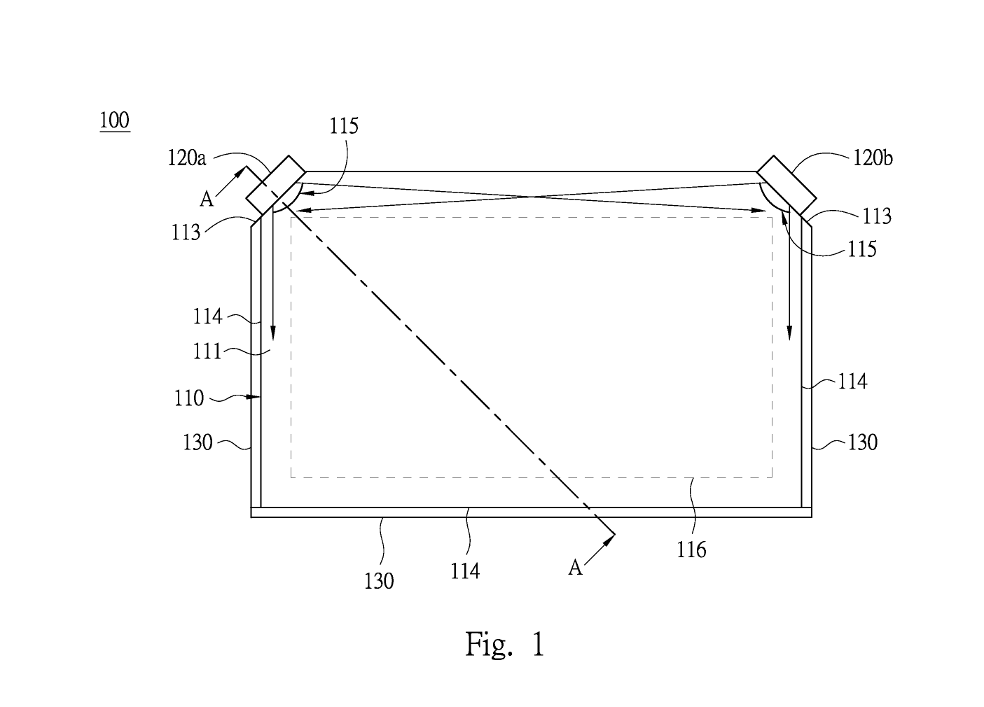

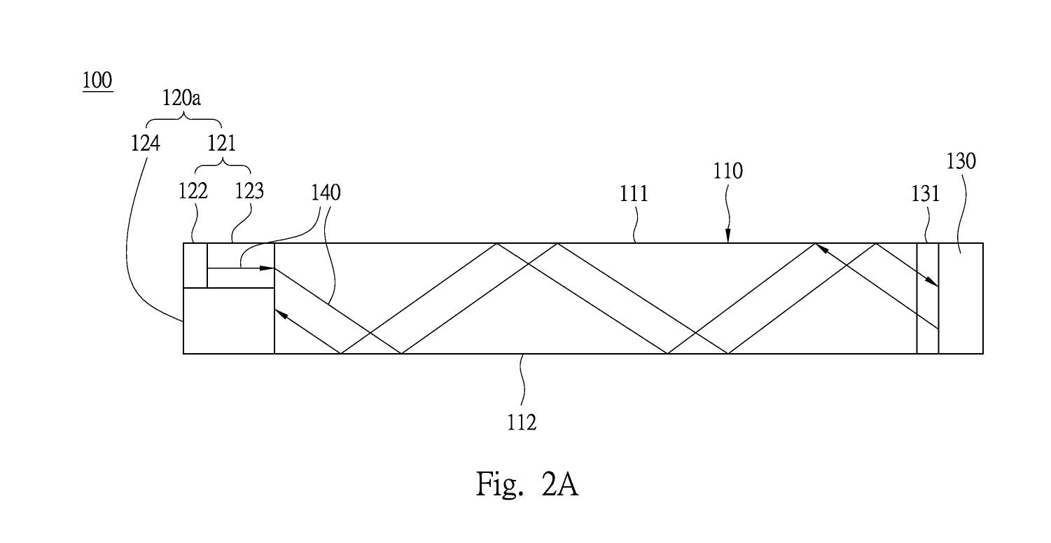

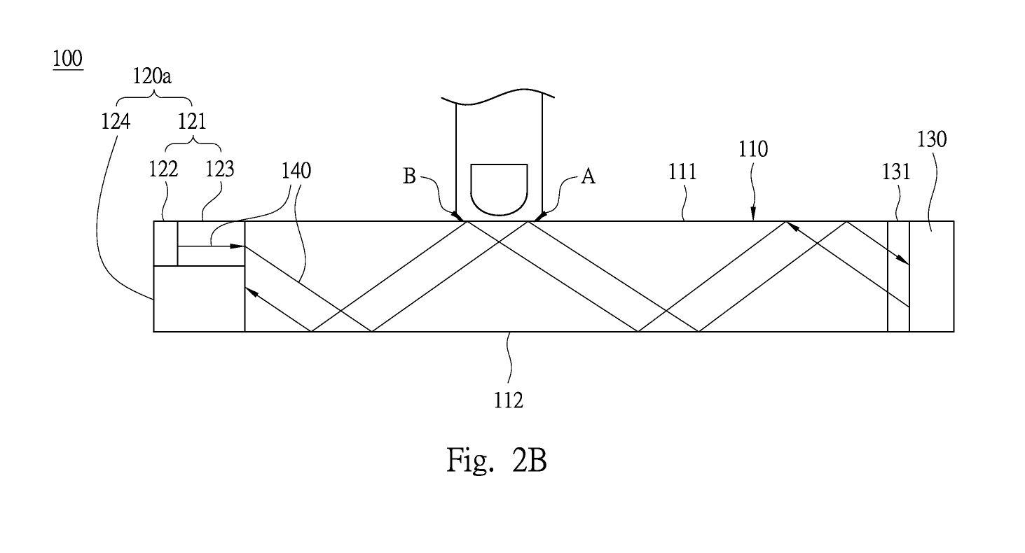

FIG. 1 is a top view of an optical touchscreen according to one embodiment of this invention. FIG. 2A is a cross-sectional view taken along line A-A of FIG. 1. As shown in FIG. 1 and FIG. 2A, an optical touchscreen 100 includes a transparent panel 110, a plurality of optical modules 120a and 120b, and at least one retro-reflector 130. The transparent panel 110 includes a first surface 111 and a second surface 112 opposite to each other, a plurality of corners 113, and a plurality of edges 114. The optical modules 120a and 120b are respectively disposed on the corners 113, and each optical module 120a and 120b includes an incident-light unit 121 and a sensor 124. The incident-light unit 121 is used for emitting an incident light 140, so that the incident light 140 enters and passes through the transparent panel 110 via a total reflection between the first surface 111 and the second surface 112. The sensor 124 is disposed on one side of the incident-light unit 121, such as the relative lower position of the incident-light unit 121. The retro-reflector 130 is disposed on the edges 114, and the retro-reflector 130 is used to reflect the incident light 140, so that the incident light 140, after being reflected by the retro-reflector 130, goes in a reversed original path within the transparent panel 110 and is captured by the sensor 124.

As shown in FIG. 2A, an emit angle of the incident light 140 can be adjusted by the incident-light unit 121, such that after the incident light 140 enter the transparent panel 110, the incident angles of the incident light 140 associated with the first surface 111 and the second surface 112 increase and that the incident light 140 passes through the transparent panel 110 in the way of total reflection between the first surface 111 and the second surface 112. The incident light 140 may pass through the transparent panel 110 to the retro-reflector 130 without exiting the transparent panel 110 (or only little incident light 140 exits the transparent panel 110). After the incident light 140 is reflected by the retro-reflector 130, the incident light 140 goes in the reversed original path and is received by the sensor 124. Due to that the incident light 140 is totally reflected between the first surface 111 and the second surface 112, there is almost no decrease in intensity of the incident light 140.

Specifically, the incident-light unit 121 can include a light source 122 and an incident-light refracting component 123. The incident-light refracting component 123 is disposed between the light source 122 and the transparent panel 110 to refract an incident light 140 emitted by the light source 122, so that after the incident light 140 enters the transparent panel 110, the incident light 140 passes through the transparent panel 110 via the total reflection between the first surface 111 and the second surface 112.

FIG. 2B is a schematic cross-sectional view of the optical touchscreen according to one embodiment of this invention. As show in FIG. 2B, if the first surface 111 is touched by a finger, the interface characteristics of the touched area of the first surface 111 may be changed. Therefore, a part of the incident light 140 may be scattered on the area between A and B of the transparent panel 110, and twice energy loss of the incident light 140 may happen in the forward direction and the backward direction. As a result, the sensor 124 may therefore receive a signal (the reflected incident light 140) with lower intensity, that could be used to determine whether the transparent panel 110 is touched.

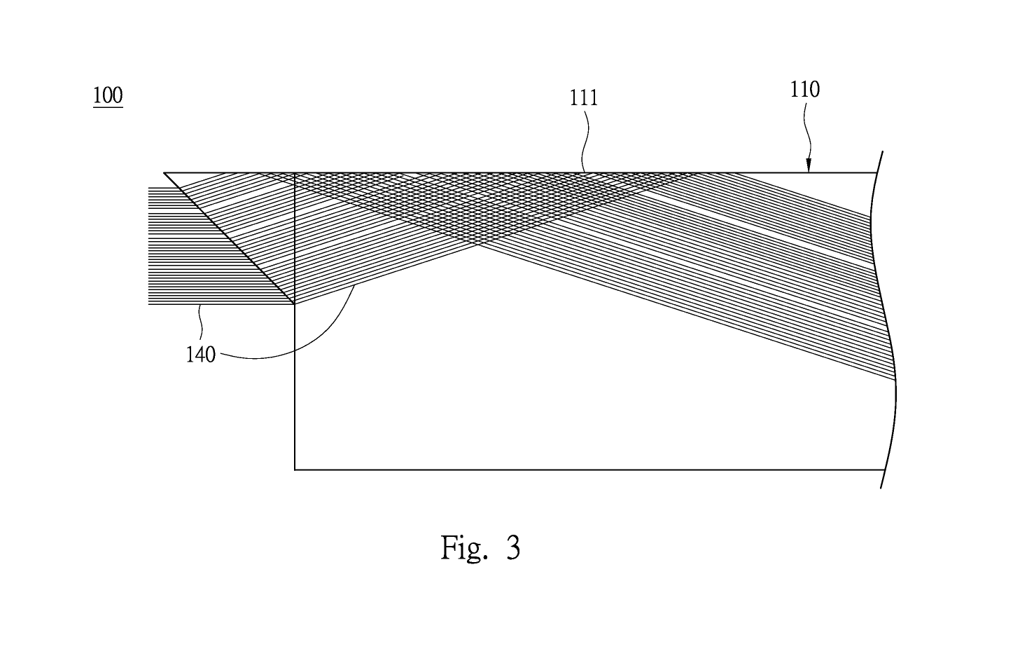

FIG. 3 is a schematic cross-sectional view of the optical touchscreen according to one embodiment of this invention. In real situations, the incident light 140 is densely distributed. Therefore, when any area of the first surface 111 is touched by a finger, the aforementioned energy loss of the incident light 140 happens.

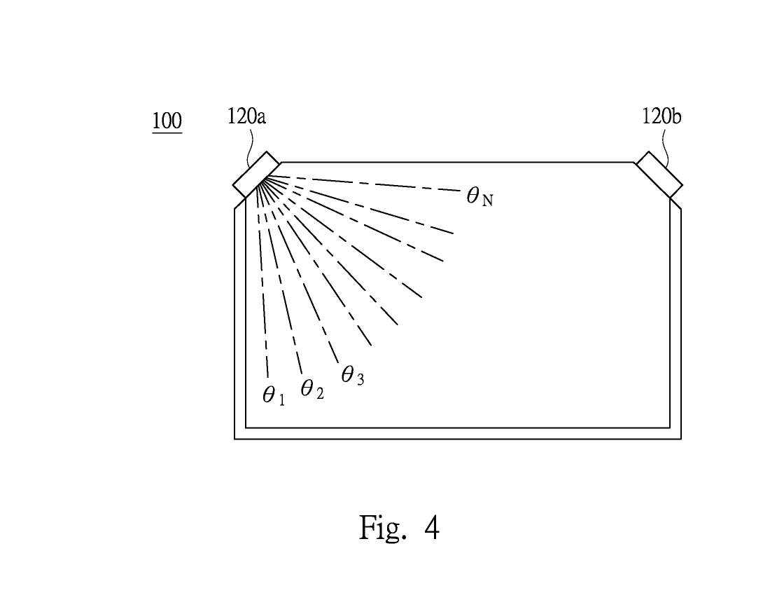

FIG. 4 is a schematic top view of the optical touchscreen according to one embodiment of this invention. As shown in FIG. 1 and FIG. 4, specifically, the transparent panel 110 can be a rectangular sheet, and the optical modules 120a and 120b are respectively disposed on the adjacent corners. The incident-light units 121 of the optical modules 120a and 120b can simultaneously emit light in large range of directions in the detection area 115, and the sensor 124 of the optical modules 120a and 120b can be used for receiving the reflected light signals in the detection area 115. For example, the optical module 120a can simultaneously emit and receive light in directions θ₁, θ₂, θ₃, . . . , θ_{N}. The optical module 120b has similar functions.

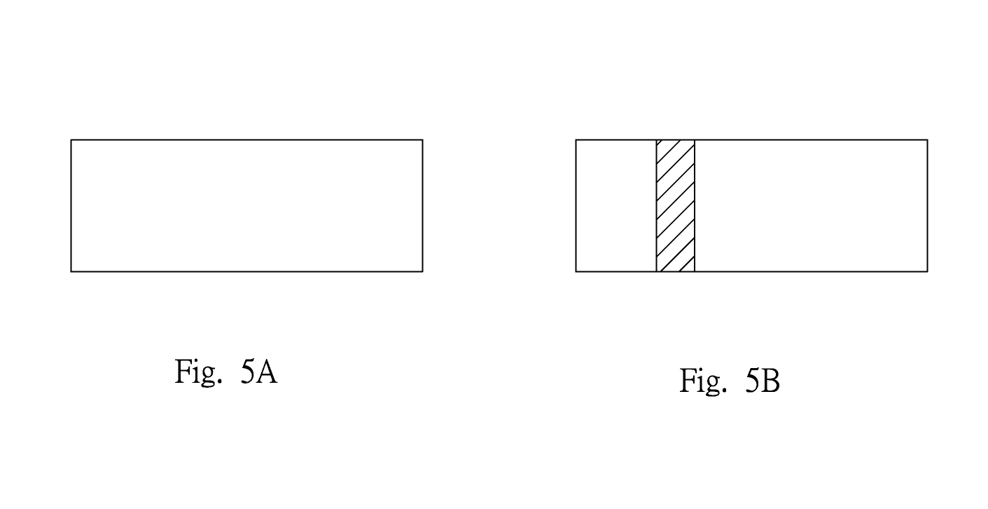

FIG. 5A is an image formed by the sensor when there is no object on the transparent panel according to one embodiment of this invention. The object can be a user's finger. As shown in FIG. 2A and FIG. 5A, the incident light 140 emitted by the incident light unit 121 advances in the transparent panel 110, and the incident light 140 is received by the sensor 124 after the incident light 140 is reflected by the retro-reflector 130. Therefore, the light signal detected by the sensor 124 corresponds to the incident light 140 emitted in the same direction, and a corresponding image signal is formed in a specific area of the whole image formed by the sensor 124. When there is no object on the transparent panel 110, an image of FIG. 5A is formed, that is, the whole image is white, for almost no energy loss of incident light 140 in all directions.

FIG. 5B is an image formed by the sensor when there is an object on the transparent panel according to one embodiment of this invention. As shown in FIG. 2B and FIG. 5B, if a finger touches the first surface 111 with a specific direction such as θ3 (as shown in FIG. 4), the incident light 140 along the direction θ3 would lose some energy, and then an image signal in an area corresponding to the incident light 140 along the direction θ3 of the whole image formed by the sensor 124 appears relatively dark, and an image of FIG. 5B is formed.

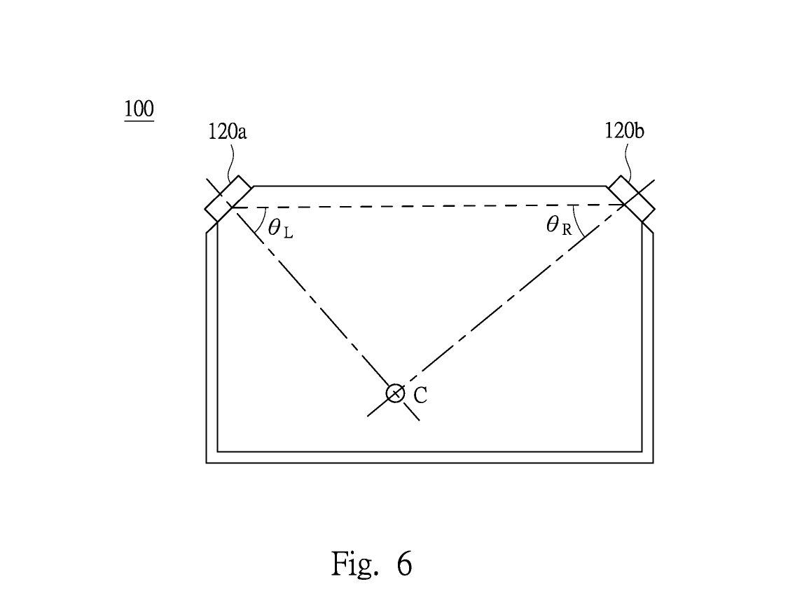

FIG. 6 is a schematic top view of the optical touchscreen when there is an object on the transparent panel according to one embodiment of this invention. As shown in FIG. 6, when a finger touches a point C on the first surface 111 (as shown in FIG. 2A), by the aforementioned methods, the angle θ_{L} formed between a first line or segment defined connecting the optical modules 120a and 120b and a second line defined connecting the optical module 120a and the point C; and the angle θ_{R} formed between the first line defined connecting the optical modules 120a and 120b and a third line defined connecting the optical module 120b and the point C can be known. At this time, by trigonometry calculation or simultaneous point-slope equations combined with the given coordinates of the optical modules 120a and 120b, the coordinates of the point C can be obtained, so as to achieve the detection.

As shown in FIG. 1, by adjusting the directions of the optical modules 120a and 120b, the detection areas 115 of the optical modules 120a and 120b can define a suitable workspace 116. The workspace 116 can include a display area of the optical touchscreen 100, and the optical modules 120a and 120b can detect the touch position of the finger in the workspace 116.

As shown in FIG. 1 and FIG. 2A, specifically, one of the edges 114 of the transparent panel 110 can be a long edge, and the optical modules 120a and 120b are disposed at the adjacent corners 113 on the long edge 114. The disposed angles of the optical modules 120a and 120b relative to the long edge 114 can be 45 degrees. The corners 113 where the optical modules 120a and 120b are disposed can be bevel structures, so that the optical modules 120a and 120b can be easily disposed and that the sensor 124 can directly laminate to the transparent panel 110.

The incident-light refracting component 123 can be directional lens. The incident-light refracting component 123 and the transparent panel 110 can be integrally single piece or two independent components. People having ordinal skill in the art can make proper modification to the incident-light refracting component 123 and the transparent panel 110 according to their actual needs.

As shown in FIG. 2, the transparent panel 110 and the retro-reflector 130 can be connected via an optical glue 131, so as to reduce an optical error due to a difference of interface characteristics. The retro-reflector 130 can be a thin layer structure. With the reflection mechanism of the retro-reflector 130, the incident light 140 goes in the reversed original path with a small translation after the incident light 140 is reflected, for example, as shown in FIG. 2A. Majority of the incident light 140 goes back to the incident light unit 121, but still small portion of the incident light 140 goes to the sensor 124. Therefore, the detection of the sensor 124 works.

A thickness of the optical module 120 equals or is smaller than a distance between the first surface 111 and the second surface 112. Therefore, when the optical module 120 is disposed on the corner 113 of the transparent panel 110, the optical module 120 does not protrude the first surface 111 and the second surface 112, so as to planarize the optical touchscreen 100.

The material of the transparent panel 110 can be glass, low-iron glass, or polymethyl methacrylate (acrylic). People having ordinal skill in the art can make proper modification to the material of the transparent panel 110 according to their actual needs.

The light source 122 can be an Infrared light-emitting diode. People having ordinal skill in the art can make proper modification to the light source 122 according to their actual needs.

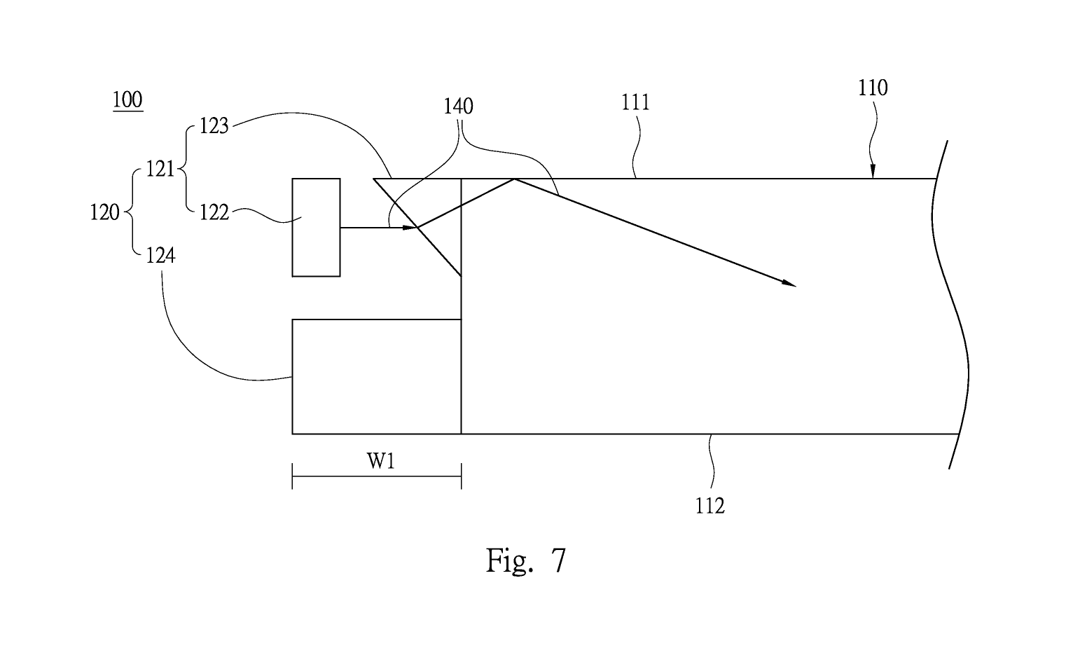

FIG. 7 is a cross-sectional view of the optical touchscreen according to another embodiment of this invention. As shown in FIG. 7, the incident-light refracting component 123 can be a prism. People having ordinal skill in the art can make proper modification to the incident-light refracting component 123 according to their actual needs.

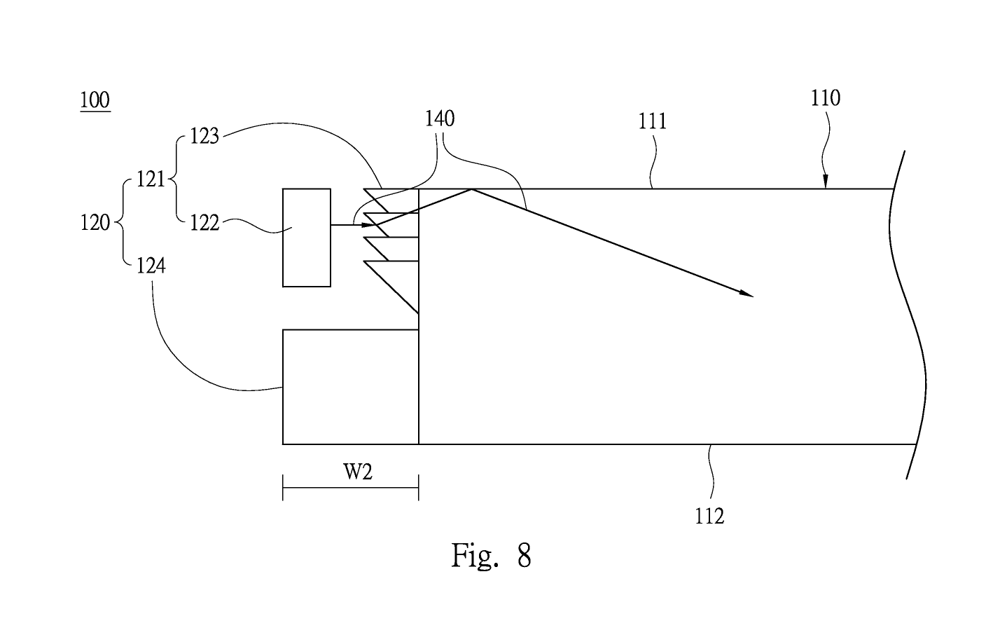

FIG. 8 is a cross-sectional view of the optical touchscreen according to another embodiment of this invention. As shown in FIG. 7 and FIG. 8, the incident-light refracting component 123 of FIG. 8 is a combination of a plurality of prisms. The size of each prism of incident-light refracting component 123 of FIG. 8 is smaller than the prism of FIG. 7, so the length between the transparent panel 110 and the light source 122 is smaller than that of FIG. 7. Therefore, the width W2 of the optical module 120 of FIG. 8 is shorter than the width W1 of the optical module 120 of FIG. 7, so as to reduce a volume of the optical touchscreen 100.

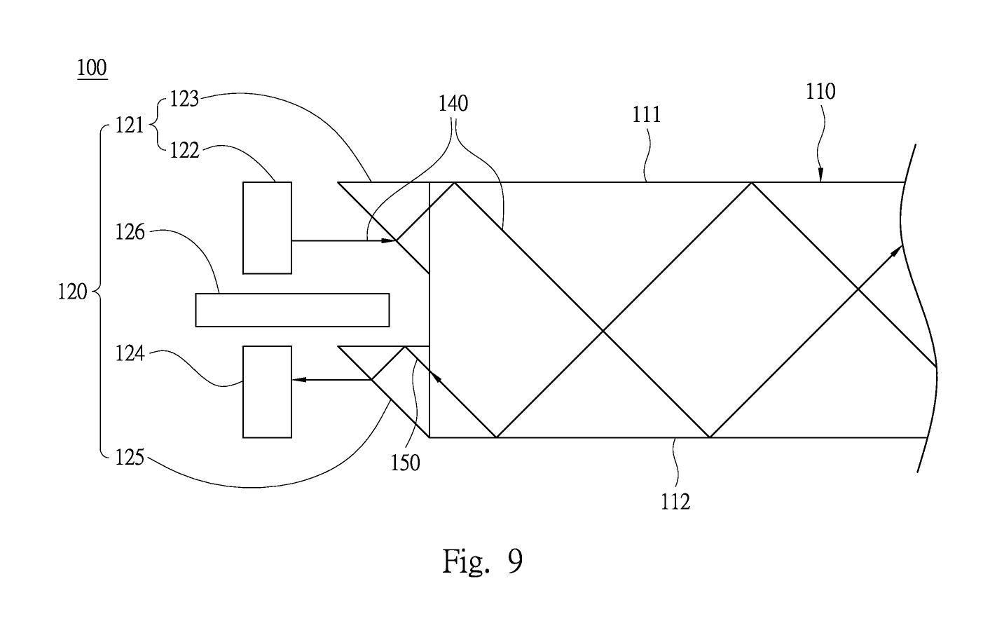

FIG. 9 is a cross-sectional view of the optical touchscreen according to another embodiment of this invention. As shown in FIG. 9, the optical module 120 further includes an exiting-light component 125. The exiting-light component 125 is disposed between the sensor 124 and the transparent panel 110 to refract an exiting light 150 from the transparent panel 110. The exiting-light component 125 can be a prism to refract the exiting light 150 and adjust a direction of the exiting light 150. The exiting-light component 125 can also be a cylindrical lens to focus the exiting light 150, such that the exiting light 150 can be easily received by the sensor 124. The exiting-light component 125 and the transparent panel 110 can be integrally single piece or two independent components.

The optical module 120 can further includes a light shading component 126. The light shading component 126 is disposed between the incident-light unit 121 and the sensor 124 to avoid light leakage from the light source 122 to the sensor 124 directly or to avoid the situation that the incident light 140 emitted by the light source 122 is reflected by the incident-light refracting component 123 and then directly emits into the sensor 124.

By the well-designed optical module 120, after the incident light 140 enters the transparent panel 110, the incident light 140 passes through the transparent panel 110 via a total reflection between the first surface 111 and the second surface 112. When a user touches the transparent panel 110 by his finger, the total reflection may be destroyed, and the intensity of the incident light 140 may decrease. Therefore, a light signal corresponding to the touch with a specific direction received by the sensor 124 may be weaken, so the position where the finger touches the panel can be known. As a result, the optical module 120 can be disposed on the side surface of the transparent panel 110 without being disposed above the transparent panel 110, so as to planarize the optical touchscreen 100.

Although the present invention has been described in considerable detail with reference to certain embodiments thereof, other embodiments are possible. Therefore, their spirit and scope of the appended claims should no be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical touchscreen, comprising:
a transparent panel having a first surface and a second surface opposite to each other, a plurality of corners, and a plurality of edges;
a plurality of optical modules respectively disposed on the corners, each of the optical modules comprising:
an incident-light unit for emitting an incident light, wherein the incident light enters and passes through the transparent panel via total reflection between the first surface and the second surface; and
a sensor disposed on one side of the incident-light unit; and
at least one retro-reflector disposed on the edges to reflect the incident light, wherein the incident light is reflected by the retro-reflector, and the reflected incident light goes in a reversed path within the transparent panel and is captured by the sensor.

2. The optical touchscreen of claim 1, wherein the incident-light unit further comprises:
a light source for emitting the incident light; and
an incident-light refracting component disposed between the light source and the transparent panel to refract the incident light emitted by the light source, so that, after the incident light enters the transparent panel, the incident light passes through the transparent panel via the total reflection between the first surface and the second surface.

3. The optical touchscreen of claim 2, wherein the transparent panel is a rectangular sheet, a number of the optical modules is two, and the optical modules are respectively disposed on the adjacent corners.

4. The optical touchscreen of claim 3, wherein one of the edges is a long edge, and the optical modules are disposed at the adjacent corners on the long edge.

5. The optical touchscreen of claim 4, wherein disposed angles of the optical modules relative to the long edge are 45 degrees.

6. The optical touchscreen of claim 3, wherein the corners which the optical modules are disposed are bevel structures.

7. The optical touchscreen of claim 2, wherein the incident-light refracting component is directional lens.

8. The optical touchscreen of claim 2, wherein the incident-light refracting component is a prism.

9. The optical touchscreen of claim 2, wherein the incident-light refracting component is a combination of a plurality of prisms.

10. The optical touchscreen of claim 2, wherein the incident-light refracting component and the transparent panel are integrally single piece.

11. The optical touchscreen of claim 2, the transparent panel and the retro-reflector is connected via an optical glue.

12. The optical touchscreen of claim 2, the material of the transparent panel can be glass, low-iron glass, or polymethyl methacrylate (acrylic).

13. The optical touchscreen of claim 2, the retro-reflector is a thin layer structure.

14. The optical touchscreen of claim 2, the light source is an Infrared light-emitting diode.

15. The optical touchscreen of claim 2, wherein the optical module further comprises an exiting-light component disposed between the sensor and the transparent panel to refract an exiting light from the transparent panel.

16. The optical touchscreen of claim 15, wherein the exiting-light component is a prism.

17. The optical touchscreen of claim 15, wherein the exiting-light component is a cylindrical lens.

18. The optical touchscreen of claim 15, wherein the exiting-light component and the transparent panel are integrally single piece.

19. The optical touchscreen of claim 2, wherein the optical module further comprises a light shading component disposed between the incident-light unit and the sensor.

20. The optical touchscreen of claim 2, wherein a thickness of the optical module equals or is smaller than a distance between the first surface and the second surface.
